(19) United States
(12) Patent Application Publication
(10) Pub. No.: US 2012/0120261 A1
(43) Pub. Date: May 17, 2012

(54) CAMERA-ENABLED REMOTE CONTROL APPARATUS FOR CONSUMER ELECTRONIC APPLIANCES

(75) Inventors: Sumat Mehra, San Jose, CA (US); Eran Steinberg, San Francisco, CA (US); Petronel Bigioi, Galway (IE)

(73) Assignee: TESSERA TECHNOLOGIES IRELAND LIMITED, Galway (IE)

(21) Appl. No.: 12/944,662

(22) Filed: Nov. 11, 2010

(51) Int. Cl. H04N 5/225; H04N 5/232

(52) U.S. Cl. 348/207.11; 348/211.2; 348/E05.042; 348/E05.024

(57) ABSTRACT

An apparatus for the remote wireless control of a consumer electronic audio and/or visual (A/V) appliance such as a TV set, and/or for internet uploading, includes a remote control handset that includes an A/V device component such as a digital still and/or video camera and/or audio player/recorder, and is configured to one or both of directly control the CE appliance, or indirectly via a wireless receiver, for playing, displaying, transitioning and/or editing audio and/or visual data, including a push-button image processing interface including multiple push-buttons configured to be depressible by one or more fingers or a thumb or both of a same hand within which the remote control handset is being held by a user.

### RELATED APPLICATIONS

This application is related to U.S. Pat. Nos. 7,694,048 and 7,685,341, and U.S. patent application Ser. No. 12/712,126, filed Feb. 24, 2010, as well as U.S. Pat. Nos. 7,747,596, 7,506,057, 7,773,118 and 7,792,970, and US published application no. 2009/0115915, and U.S. Ser. No. 12/824,224, filed Jun. 27, 2010, and Ser. No. 12/876,209, filed Sep. 6, 2010, which are each assigned to the same assignee and hereby incorporated by reference.

### BACKGROUND OF THE INVENTION

1. Field of the Invention

The invention relates to a wireless camera-enabled remote control apparatus for consumer electronic (CE) appliances, and to systems and methods for transferring and controlling audio and/or visual data (hereinafter “A/V data) from acquisition devices, through a wireless camera-enabled remote control apparatus, and onto an output display devices.

2. Description of the Related Art

Traditionally, domestic homes have contained stand-alone CE appliances such as TV sets or single add-on appliances such as VCR and DVD players which allow the recording of TV shows and playing of pre-recorded movies. However, the last few years have seen a substantial growth in audio and visual content derived from digital appliances and made available to consumers in digital form. Examples include digital cameras for digital imaging and MP3 digital encoding for audio data, as well as digital video cameras. Broadly speaking most consumers now find digital content more flexible and useful than conventional analog media. However, although most digital content can be readily managed and post-processed on a conventional desktop computer, this is not necessarily the best location for a consumer to enjoy such content.

Accordingly a new generation of peripheral add-on CE appliances have emerged, such as Picture Display Devices and Media Adapters, whose goal is to enable the viewing of digital content using more conventional CE appliances such as a TV set. A Media Adapter is an appliance which can receive digital content over a network connection and convert it to standard RCA, S-Video, HDTV or DV output for presentation on a standard TV set. Typically such an appliance sources its content from a networked desktop computer.

The PrismIQ Media Adapter (www.prismiq.com) is a good state-of-art example of such an appliance. It allows audio, video and still photo content located on a networked home computer to be viewed on a home TV-set. The PrismIQ features audio and video outputs which allow it to be connected directly to a standard TV set. It may be networked with the home computer via either wired, or wireless network connections. The main PrismIQ appliance can then be managed by the user with a conventional remote control unit, thus allowing the display of digital content on the TV set from a couch in the living room. Even with the PrismIQ, however, digital content is first loaded onto a desktop computer and pre-processed by a specialized server application prior to being accessible by the user from the comfort of his living room.

Picture Display Devices such as Digital-Album by Nixvue Systems Ltd. (www.nixvue.com), generally include a “set-top box” which plugs physically into a television set and contains one or more readers for a removable storage medium, such as a memory card, containing audio and/or visual data content. Operating picture display devices, however, involves users plugging the removable storage medium into the box, returning to their seats and activating then remote control unit. This becomes awkward if users have multiple removable memory cards that they wish to review or organize. That is, operating picture display devices involves users moving from the couch to the TV set or box in order to switch removable memory cards.

### BRIEF DESCRIPTION OF THE DRAWINGS

Preferred and alternative embodiments are described below by way of example with reference to the accompanying drawings, in which:

FIG. 1a is a block diagram of an embodiment including a removal storage medium reader wherein the output device is a display device such as a television set.

FIG. 1b is a block diagram of an embodiment including a cable-based USB interface to the acquisition device.

FIG. 1c is a block diagram of an embodiment wherein the output device is a printer.

FIG. 1d is a block diagram of an embodiment wherein the output device is an Internet upload device.

FIG. 2 is a block diagram of a further embodiment including a remote control signal connecting wirelessly with a digital camera.

FIG. 3 is a block diagram of a camera adaptor unit.

FIG. 4 is a perspective view of an embodiment of a remote control handset.

FIG. 5 is workflow diagram illustrating operation of a system in accordance with a preferred embodiment, including two alternative sources of digital images.

FIG. 6a schematically illustrates a camera-enabled remote control handset in wireless communication with a wireless receiver and display unit in accordance with certain embodiments.

FIG. 6b schematically illustrates a camera-enabled remote control handset in wireless communication with a wireless receiver, display subsystem and CE appliance in accordance with certain embodiments.

FIG. 6c schematically illustrates a camera-enabled remote control handset in accordance with certain embodiments, where only a single camera block is intended to indicate that the device includes flash, lens, image sensor, processor and programming of a digital still image, video image and/or audio acquisition, display and or audio output device.

FIG. 6d schematically illustrates a camera-enabled remote control handset in wireless communication with a wireless receiver and internet upload device in accordance with certain embodiments.

### DETAILED DESCRIPTION OF PREFERRED EMBODIMENTS

An apparatus is provided, in accordance with certain embodiments, for remote wireless control of a consumer electronic (CE) appliance and/or of internet uploading. The apparatus for CE control includes a camera-enabled remote control unit and a wireless receiver for indirect connection to the CE appliance and/or direct connection to the CE appliance. The remote control unit is adapted to transmit audio and/or visual data (hereinafter “A/V data”; visual data including video or still image data, or both) and control codes to the receiver and/or CE appliance. The receiver is responsive to the A/V data and control codes from the remote control unit to control the appliance to play and/or display the A/V data.

Preferably, the same camera-enabled remote control unit may be configured to indirectly control the wireless receiver and to directly control the consumer electronic appliance and to acquire A/V data using a built-in imaging optical system, image sensor and digital still image and/or digital video storage medium and/or digital audio system. The remote control unit may also have its own display and processor for controlling image acquisition, storage, transmission, display and/or editing or otherwise further processing A/V data.

The remote control unit may include a reader for a removable storage medium for A/V data. The A/V data transmitted to the receiver and/or CE appliance may be read from the storage medium. The camera-enabled remote control unit may also include a cable or wireless interface for signal connecting to another A/V acquisition device, such as a digital still camera, digital video camera or digital audio player, e.g., using an industry accepted interface.

In certain embodiments, a camera-enabled remote control handset and a memory card reader subsystem are combined into an integrated appliance. In another embodiment, a camera-enabled remote control handset and an interface to a digital media acquisition device are combined into another integrated appliance. These integrated appliances allow digital media, particularly digital images, video and/or audio, to be accessed directly by a consumer upon acquisition by the camera-enabled remote control handset, or from a removable memory card, or from another acquisition device, and to be subsequently transmitted over a wireless link for direct display on a TV set or other digital display appliance, and/or upon acquisition of audio by the remote control handset. This has the advantageous of eliminating the need for the user to move from the couch to the TV set just to switch removable memory cards, and/or to grab a separate camera or camera-phone. The remote control unit may have further integrated resources such as a phone, bar code reader, video conferencing, etc.

The camera-enabled remote control handset may also control of an internet uploading device (e.g., a pc computer connected to a web server) and/or may itself serve as an internet uploading device or as an access point for a wireless network. The camera-enabled remote control unit may couple with a wireless receiver for direct control of an internet uploading device and/or may directly control such device. The camera-enabled remote control unit may be adapted to transmit internet content and control codes to the receiver and/or internet uploading device. The receiver may be responsive to the content and control codes from the camera-enabled remote control unit to control the uploading of the internet content, e.g., to a web page or database. Other features described with respect to the CE appliance control apparatus may be utilized in the internet upload apparatus.

A method for the remote wireless control of a consumer electronic (CE) appliance is also provided. A/V data is acquired by the camera-enabled remote control handset and/or received from another A/V acquisition device at an interface of a remote control unit. The A/V data and control codes are transmitted to a wireless receiver coupled to a CE appliance and/or directly to the CE appliance. The receiver and/or CE appliance may be configured to be responsive to the data and control codes received from the camera-enabled remote control unit to control the CE appliance to play and/or display or otherwise output the A/V data. Other features described with respect to the CE appliance and internet upload control apparatuses may be utilized with the method.

An apparatus for the remote wireless control of a consumer electronic (CE) appliance in accordance with certain embodiments includes a camera-enabled remote control handset that is configured to one or both of directly control the CE appliance, or indirectly via a wireless receiver, for playing, displaying, transitioning or editing audio or visual data (hereinafter “A/V” data), or combinations thereof, including a push-button image processing interface including multiple push-buttons configured to be depressible by one or more fingers or a thumb or both of a same hand within which the remote control handset is being held by a user. The remote control handset includes an integral A/V device and has a display. The camera-enabled remote control handset is configured for processing A/V data prior to transmission for output at the CE appliance, and/or a wireless receiver coupled to the CE appliance is configured for processing the A/V data prior to playing and/or displaying the data on the CE appliance.

The remote control unit may be configured to transmit the A/V data and control codes wirelessly to the CE appliance and/or to the wireless receiver. The CE appliance and/or the wireless receiver is configured to be responsive to the A/V data and control codes from the camera-enabled remote control handset, and to output the A/V data at the CE appliance. The CE appliance, wireless receiver and/or remote control handset is configured to process the A/V data responsive to metadata associated with the A/V data, including dust or other blemish removal, motion blur compensation, transition effects, color correction, exposure correction, red eye reduction, rotating, panning, scrolling or cropping, or editing an object, selecting which objects to display, or erasing and reordering objects, or combinations thereof, under the push-button control of the remote control handset for providing a processed image or processed A/V data, or both, to be output at the CE appliance based on the processed image data.

The remote control handset may be configured to directly control the CE appliance and/or to indirectly control the CE appliance through a wireless receiver.

The camera-enabled remote control handset may include an internal storage for storing A/V data.

The interface may be configured according to Picture Transfer Protocol (“PTP”).

The A/V device component of the camera-enabled remote control handset may include a digital stills camera, a digital video camera and/or a digital audio player.

The consumer electronic appliance may include a display unit, such as a television set or other monitor device. The display unit may be controlled directly by the wireless receiver or by the camera-enabled remote control handset.

The remote control unit is configured for processing A/V data prior to transmission to the wireless receiver and/or directly to the CE appliance. The wireless receiver may be configured for processing the A/V data prior to playing and/or displaying the data on the CE appliance.

A method for the remote wireless control of a consumer electronic (CE) appliance is also provided in accordance with certain embodiments. Audio or visual data, or both (hereinafter “A/V” data) are acquired at an A/V device component of a remote control handset, wherein the interface of the remote control handset comprises a display unit. A/V data may be processed prior to transmission to a wireless receiver coupled to the CE appliance, and/or processing of the A/V data may be controlled by the remote control handset prior to playing and/or displaying the data at the CE appliance and/or at a wireless receiver coupled to the CE appliance. The A/V data and control codes are transmitted to the wireless receiver and/or CE appliance which is configured to be responsive to the A/V data and control codes from the remote control handset to control the CE appliance to output the A/V data.

The CE appliance may be directly or indirectly controlled for playing, displaying, transitioning and/or editing the A/V data. A/V data processing may be performed at the wireless receiver, at the CE appliance and/or at the remote control handset in response to metadata associated with the A/V data, including one or more of dust or other blemish removal, motion blur compensation, transition effects, color correction, exposure correction, red eye reduction, rotating, panning, scrolling or cropping, and/or editing an object, selecting which objects to display, and/or erasing and reordering objects. The A/V data processing is controlled with the remote control handset, which is configured to be held in a single hand of a user. A push-button image processing interface including multiple push-buttons of the remote control handset may be used by selectively depressing the buttons with one or more fingers or a thumb or both of the same hand within which the remote control handset is being held by the user. Processed A/V data and/or a processed image may be output based on the A/V data processing.

The method may further include any of the following: controlling the CE appliance directly or indirectly through a wireless receiver; controlling the receiver to control the CE appliance for playing, displaying, transitioning and/or editing the A/V data; storing A/V data at an internal storage; configuring the interface according to Picture Transfer Protocol (“PTP”); and/or processing A/V data prior to transmitting to the wireless receiver and/or directly to the CE appliance.

The A/V device component of the remote control handset may include a digital stills camera, a digital video camera, and/or a digital audio player.

One or more processor readable storage devices are also provided that have processor readable code embodied thereon for programming one or more processors to perform any of the methods for the remote wireless control of a consumer electronic (CE) appliance described herein.

An apparatus is also provided for the remote wireless control of internet uploading. A camera-enabled remote control handset is configured to directly, and/or indirectly through a wireless receiver, control an internet upload device for playing, displaying, transitioning, editing, and/or uploading to the internet, audio and/or visual data (hereinafter “A/V” data). The remote control handset includes a push-button image processing interface including multiple push-buttons configured to be depressible by one or more fingers or a thumb or both of a same hand within which the remote control handset is being held by a user. The remote control handset may include an A/V device component as well as a display. The remote control handset may be configured to communicate internet content and/or to transmit the internet content wirelessly to a wireless receiver coupled to an internet upload device, and/or directly to the internet upload device for uploading content to be accessible on the internet. The remote control unit, the wireless receiver, and/or the internet upload device may be configured for processing the A/V data prior to uploading content to be accessible on the internet.

The remote control handset may be configured to transmit the A/V data and control codes wirelessly to the wireless receiver, and/or to the internet upload device. The wireless receiver and/or internet upload device may be configured to be responsive to the internet content and control codes from the remote control handset, and to process the A/V data responsive to metadata associated with the A/V data, and to control the internet uploading of the content. The wireless receiver, the internet upload device and/or the remote control handset may be configured to process the A/V data, including dust or other blemish removal, motion blur compensation, transition effects, color correction, exposure correction, red eye reduction, rotating, panning, scrolling or cropping, and/or editing an object, selecting which objects to display, and/or erasing and reordering objects, under the push-button control of the remote control handset for providing a processed image and/or processed A/V data to be uploaded to the internet based on the processed image data.

The remote control handset may be configured to directly, or indirectly through a wireless receiver, control the internet upload device.

The A/V device component of the remote control handset may be configured to acquire digital still images, to acquire digital video images and/or to play and record digital audio.

The remote control unit may be configured for processing internet content prior to transmission to the wireless receiver, and/or to the internet upload device.

The wireless receiver and/or the internet upload device may be configured for processing the internet content prior to internet uploading.

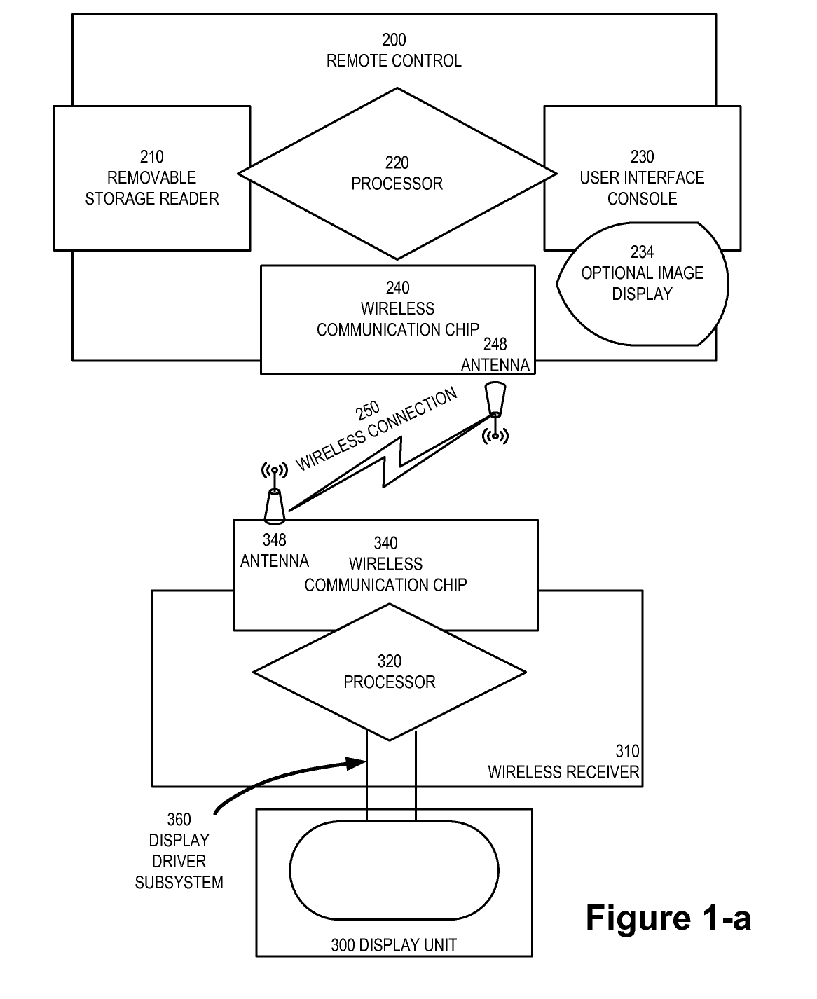

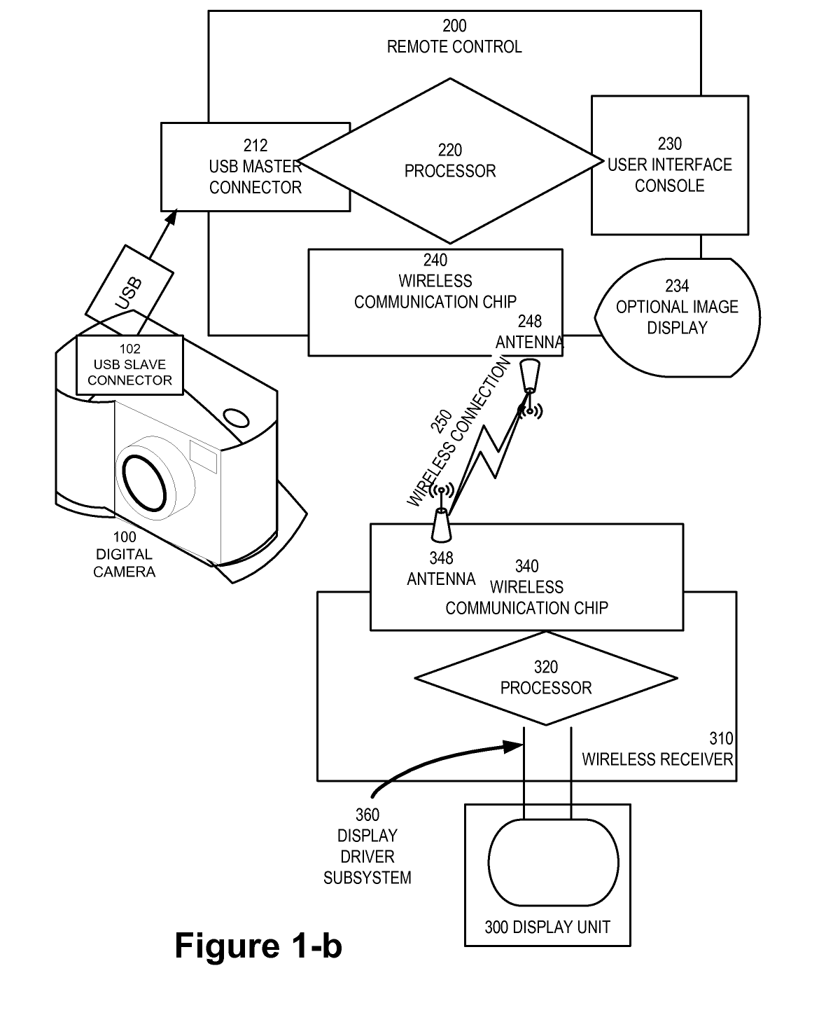

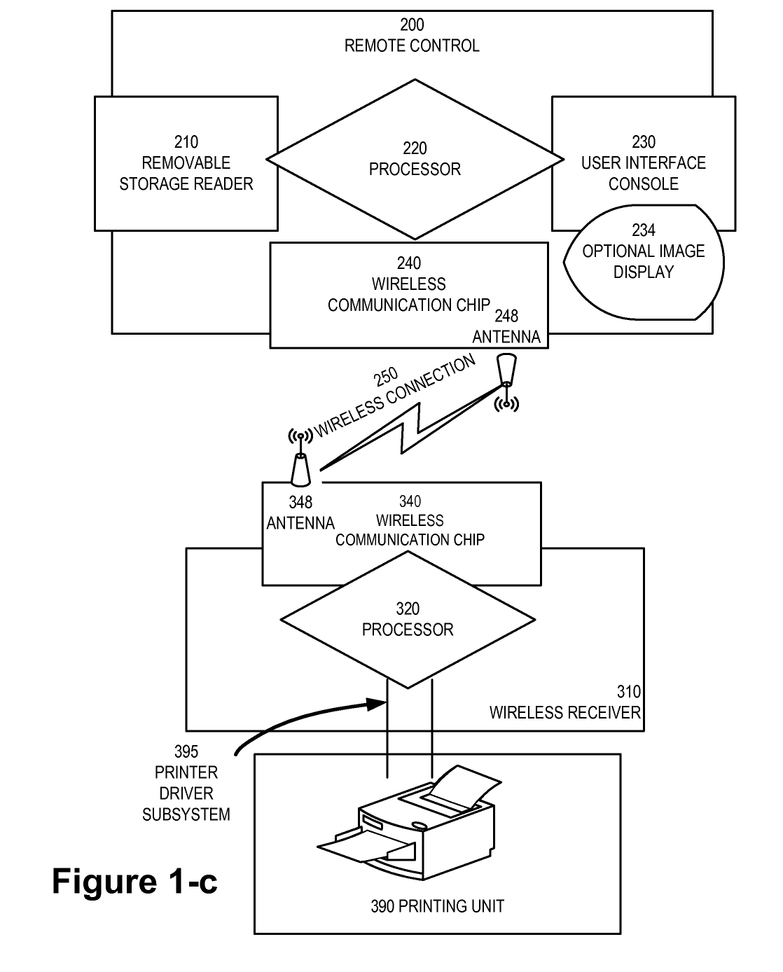

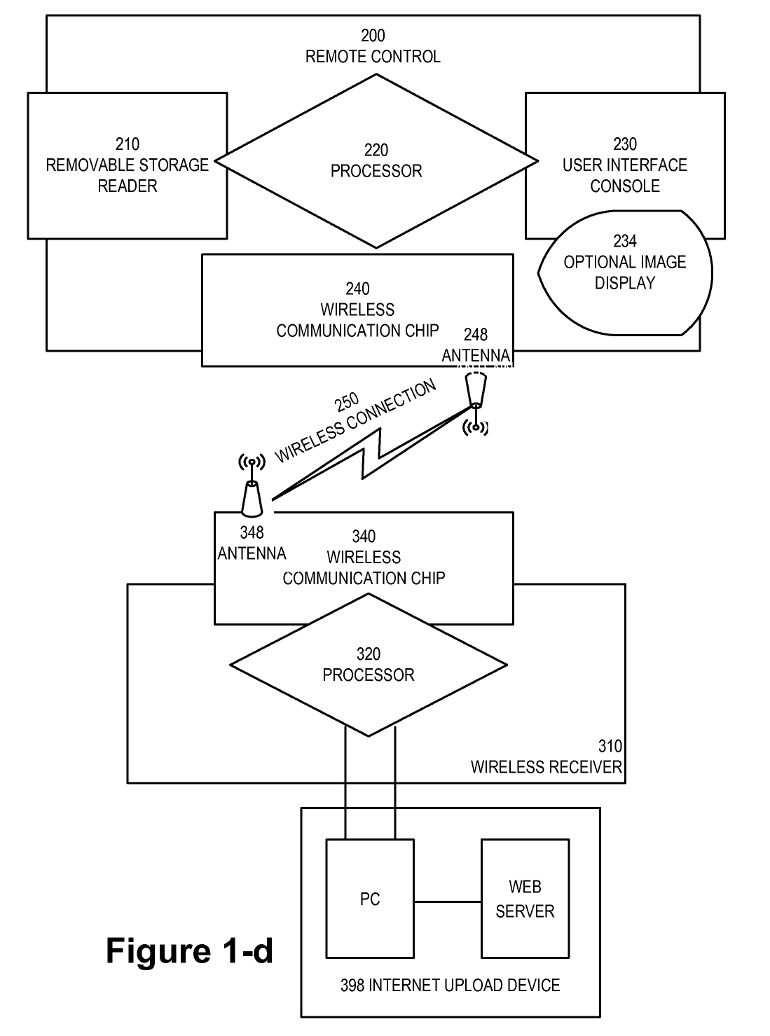

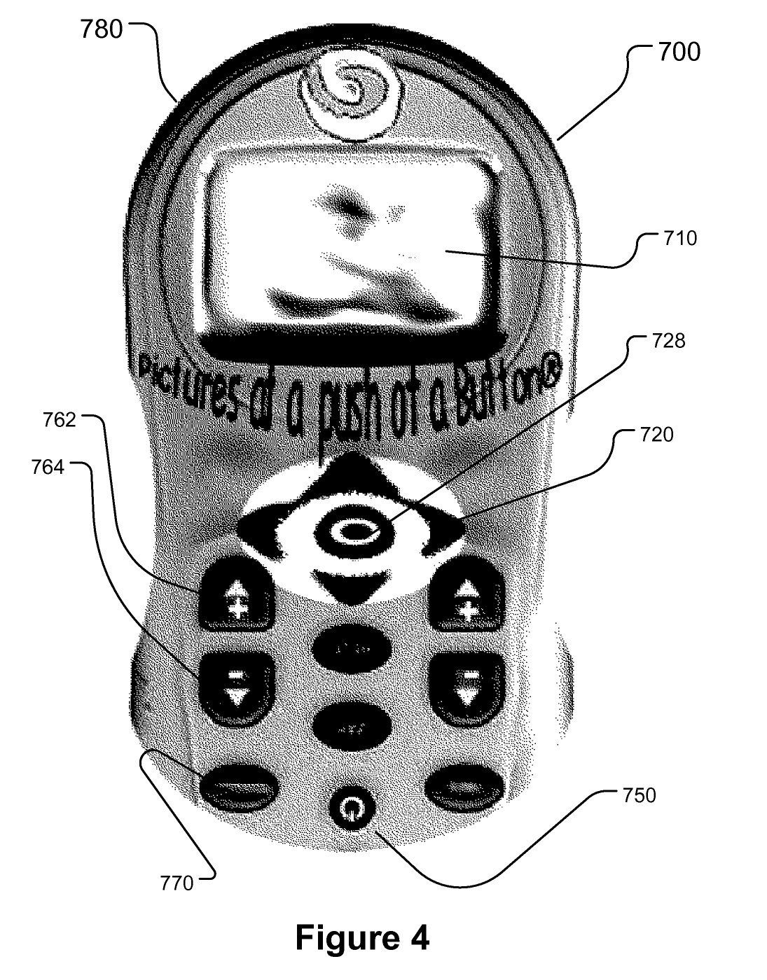

FIG. 1-a is a block diagram of a system in accordance with a preferred embodiment. Referring to FIG. 1-a, the system includes a remote control unit 200, which may preferably be implemented as a handset, the embodiment illustrated at FIG. 4, and/or a docking station. The remote control unit 200 of FIG. 1-a is shown communicatively coupled with a wireless receiver 310. The remote control unit 200 comprises a main processor 220. The main processor is preferably an embedded processor such as a dedicated system-on-chip integrated circuit, for example, a standard ARM or MIPS based embedded system. The processor 220 shown in FIG. 1-a is interfaced to a number of peripheral subsystems commonly found in consumer remote control units: a user interface console 230 and a wireless communications chip 240. The user interface console 230 is, for example, a keyboard subsystem allowing the user to select and initiate various control functions by initiating the wireless transfer of control codes to a remote CE appliance such as a TV set or other display unit 300.

FIG. 1-c illustrates another embodiment wherein, instead of a display unit 300 such as a television set or other electronic audio and/or visual display device, the display unit 300 of FIGS. 1-a and 1-b is replaced by a hardcopy device such as a color printer 390. In the embodiment of FIG. 1-c, a printer driver 395 is also used instead of the display driver subsystem 360 shown in FIGS. 1-a and 1-b.

Another embodiment is illustrated at FIG. 1-d, wherein the data is internet content that may be communicated to an internet upload device 398, such as a pc or other processor-based device that is connected to a web server. The content may be uploaded to a web page or a database or other construct that is accessible via the internet.

Many remote control units 200 also feature an optional image display 234, for example, a LCD display. The display 234 may be an uncomplicated alphanumeric display, or may be a more sophisticated graphical color LCD display or any other display device known to those skilled in the art. A wireless communication chip 240 is preferably employed to communicate control codes (instructions) to the remote CE appliance 300, 390. An infrared based means of transmitting control codes may be employed, or alternative communication means such as Bluetooth or WiFi, WUSB or WLAN may be used. Such Radio Frequency communications may use an antenna 248. These and other subsystems may be used including those that may be common to domestic remote control units for direct control of a CE appliance 300, e.g., those that bypass wireless receiver 310.

The remote control unit 200 preferably also incorporates a removable storage medium reader 210, for example, a card reader subsystem for accessing data from removable storage media such as compact flash data cards. Alternatively, as illustrated at FIG. 1-b, the remote control unit 200 may have a cable or wireless signal communication interface to an A/V device. As utilized herein, the term “interface” is meant to be any architecture for permitting communication of the A/V data from the A/V device to the remote control unit 200 including a card reader 210, USB or other cable interface 212, or wireless interface. A digital camera 100 may communicate A/V data to the remote control unit 200 through a common cable communication system, such as may be installed on many standardized A/V devices. Such communication system may be a USB master 212 which interfaces with the device 100 through a USB slave connector 102, or a proprietary interface such as ImageLink. Interfacing with such A/V devices may be made using known protocols such as ISO-15740 command language for cameras also known as Picture-transfer-Protocol or PTP. In this scenario, the remote control unit 200 can also act as a docking station for the A/V device 100.

A system in accordance with a preferred embodiment has the advantage that digital audio and/or visual (A/V) content data may be accessed by the remote control unit 200 from removable storage media in the reader 210 or via a cable or wireless interface from the device 100. Moreover, such data, stored in internal storage (not shown) in the device 100, may be further managed, manipulated, combined and otherwise processed by the processor 220 on the remote control unit 200. After this data has been accessed and suitably prepared, it may be transmitted to the remote wireless receiver 310 along with a sequence of control codes instructing the receiver 310 as to the handling and playing/displaying of the data.

The wireless receiver 310 of FIGS. 1-a and 1-b includes a main processor 320, preferably an embedded processor, typically a dedicated system-on-chip integrated circuit. This processor 320 is connected to two main peripheral subsystems: a wireless communication chip 340 with antenna 348 and a display driver subsystem 360, for example, an RGB/NTSC/PAL/D1/VGA/HDTV/D1-4 interface which is connected, in turn, to a CE display unit such as a conventional TV set 300. The wireless communication chip 340 is employed to receive, via the wireless connection 250, control codes transmitted from the remote control unit 200 and, in addition, A/V data which is read from the removable storage medium inserted into the remote control unit 200.

The protocol used on the wireless connection 250 may be generic or a specific protocol for the imaging devices used. Examples include using similar protocol between image acquisition devices and hosts such as PTP or in the wireless case PTP-IP or MTP over IP (“MTP-IP”). In the embodiment illustrated at FIG. 1-c, wherein the output device is a printer 390, such protocols as PictBridge may be used to transfer the data over wireless connection 250. The CE display unit 300 of the embodiments illustrated at FIGS. 1-a and 1-b is preferably a digital display unit such as an LCD panel or HDTV.

When A/V content data is received, it will typically be preceded by an identifier indicating the type or format of the content (i.e. audio, visual or both) and may also incorporate additional metadata including recording image processing modifications performed on the remote control unit 200. Image processing may alternatively or additionally be performed by the processor 320 on the receiver 310. The receiver-side image processing may be responsive to metadata associated with the A/V content data. As an example, a user may program a slideshow sequence on the remote control unit 200 and then transmit the resulting A/V data to the receiver 310. Further image processing, including transition effects, redeye removal, blemish removal such as from dust, and/or motion blur compensation can be performed in the receiver 310 prior to the actual rendering of the slideshow image sequence on a TV or other display unit 300. Such image processing may also be managed directly from the remote control unit 200. Thus, the receiver 310 may directly control the display unit 300 to play (in the case of audio or movies) and/or display (in the case of still images) the A/V content data.

Alternatively, remote control unit 200 may control the unit 300 indirectly via the receiver. Such control may include the transition between objects, editing the object, selecting which objects to display, and/or erasing and reordering objects. Editing objects may include operations such as color correction, red eye reduction, rotation, exposure correction, and cropping.

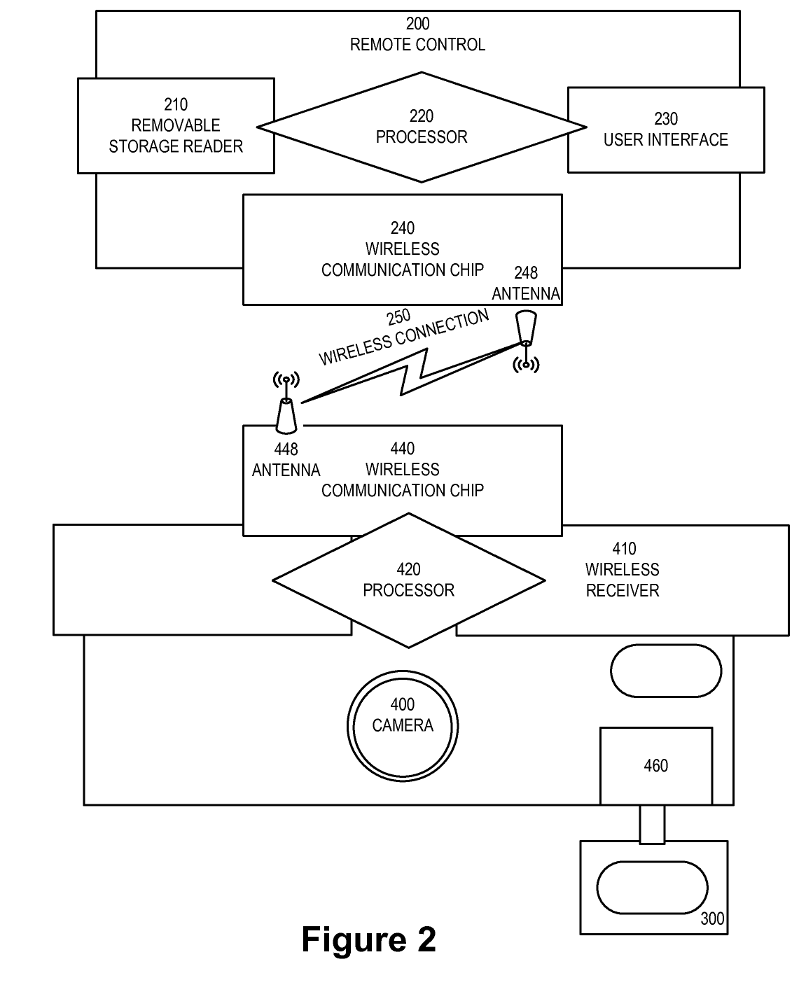

Another embodiment is illustrated at FIG. 2. In this embodiment, the remote control unit 200 is preferably the same as or similar to that described in the FIGS. 1-a through 1-c. In this case, however, the wireless receiver 410 is connected to a digital camera 400 or similar imaging appliance. An advantage of this alternative embodiment is that a digital camera will, typically, incorporate a display subsystem 460 which allows it to be connected to a conventional audiovisual CE appliance such as a TV set 300. Furthermore, the latest digital cameras incorporate WLAN or Bluetooth subsystems. Accordingly, a digital camera with such wireless communications and display subsystems can be modified to take advantage of the remote control unit 200 with removable storage reader 210. In other words, in this embodiment the receiver 410 controls the display unit 300 to play and/or display the A/V content data via digital camera 400.

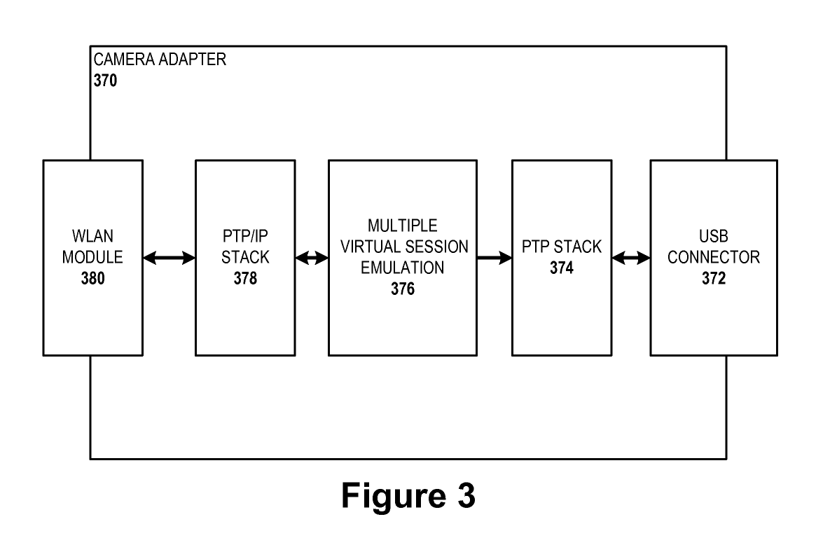

In a practical exemplary implementation of this alternative embodiment, the camera is a PTP-enabled digital camera, such as may be described at (i) “Digital camera connectivity solutions using the picture transfer protocol (PTP)” to Bigioi, P.; Susanu, G.; Corcoran, P.; Mocanu, I and published in IEEE Transactions on Consumer Electronics, volume 48, issue 3, p417-427, August 2002; or (ii) PTP/ISO-15740 PTP Specification, available from http://www.i3a.org/downloads_it10.html, which are hereby incorporated by reference. The camera 400 is preferably connected to an adapter unit 370 such as that illustrated in block form at FIG. 3. The adapter unit 370 of FIG. 3 may correspond generally to wireless communication chip 440 of FIG. 2. The camera adapter unit 370 incorporates a USB connection 372, which allows a PTP-enabled digital camera to be connected to the adapter system. It further provides a PTP stack 374, which provides access to the PTP functionality of the digital camera. The adapter also incorporates a WLAN interface module 380, which provides connectivity to an external wireless network. This module 370 may be replaced by Infrared, Bluetooth or Powerline communications modules. Implicitly contained within the WLAN communications module is a TCP/IP stack (or a Bluetooth, Infrared or Powerline stacks as appropriate to the physical communication chip be used).

A PTP/IP stack 378 is also incorporated in the main adapter, thus providing remote access to the PTP functionality of the camera. One further software module is preferably used to fully enable wide-area networking support for remote access to the PTP-enabled digital camera. This is a multiple virtual session emulation module 376. This module 376 is preferably used because the PTP protocol that is designed to support point-to-point communications between a camera and a desktop computer typically does not support the concept of multiple connected devices or multiple concurrent device sessions. Support for these concepts is embodied in the PTP/IP protocol, but this also requires some OS-level support from the device within which the PTP/IP stack is implemented. Thus, as the PTP/IP stack is not directly implemented within the generic PTP camera, it is necessary to provide some emulation support for device and session IDs within the adapter itself. Wireless receivers 310, 410 have been shown as separate components in the illustrative embodiments. However, they could be incorporated into the display unit 300 or digital camera 400.

FIG. 4 illustrates a physical implementation of a remote control unit 700 corresponding to the unit 200 shown in the block diagrams of FIGS. 1-a, 1-b, 1-c and 2. The remote control unit 700, which may be similar in form and function to conventional known remote control units, preferably exhibits some additional features designed to accommodate the principle elements of the embodiments described herein.

First, it may incorporate a slot 780 in the casing of the remote control unit to accommodate the insertion and removal of a removable storage medium into the reader 210 (see FIG. 1-a). Alternatively, slot 780 may be a USB master plug 212 (see, e.g., FIG. 1-b) which will accept a USB cable from the camera 100. In addition, it may incorporates special function keys 770 to initiate customized image processing algorithms which can enhance or improve the digital content that may be accessed and further managed, manipulated, combined or otherwise processed on the remote control unit 700.

In addition to automated image processing functions, the remote control unit 200, 700 may optionally incorporate a graphical LCD display 710 which can display images loaded from the removable storage medium subsystem 210. This allows for additional image processing and enhancement functions to be performed on the remote control unit 700 where user input from the remote control keys 762, 764 may be used to adjust a parametric input to the image processing and functions such as brightness or exposure.

Further advanced functionality can be achieved using more complex user input such as may be obtained from an “arrow-key” input button 720 which can allow accurate panning, zooming and scrolling of a selected image. An OK/Enter button is indicated at 728 and an ON/OFF button is indicated at 750 of FIG. 4.

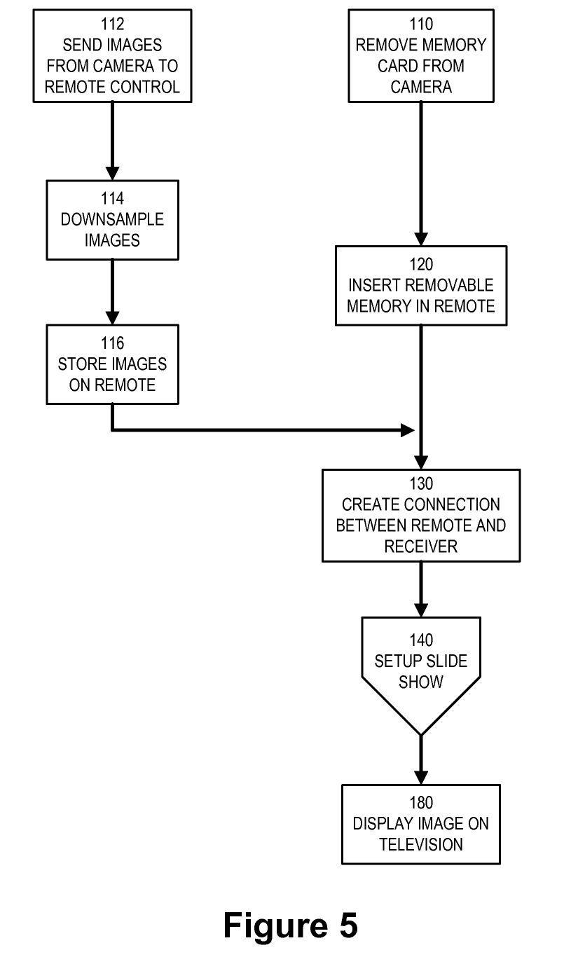

An exemplary workflow is illustrated in FIG. 5 for the transmission of, in this example, still images. At block 110, a memory card is removed from a digital camera or similar imaging device, and then inserted into the card reader of the remote control unit at block 120. A communications link is then automatically or manually activated between the remote control unit 200, 700 and the wireless receiver at block 130. According to this embodiment, the receiver may be an adapter connected to a standard TV set, or alternatively an adapter connected to a digital camera with a display output suitable for providing a signal to a TV set. As stated, these adapter units may be incorporated internally within the TV set or digital camera, rather than being separate appliances. Alternatively, the functions illustrated at block 130 may be operated on an intermediate device such as a centralized remote control box, a digital camera or a home server that will indirectly control the receiver.

After the communications channel between the remote control unit and the receiver is established, the user may next initiate a sequence of image transfers between the remote control unit and the receiver at block 140. These transfers may be a sequential display of all the images stored on a memory card, or may alternatively be sequenced by the user, or randomly sequenced. The system may optionally provide support for an interactive user interface (UI) wherein the remote control unit enables a video overlay subsystem within the host device to be activated. The user may then navigate the displayed overlay UI using the remote control keys and thus achieve a more advanced control over the sequencing and transitions for a slide-show display of the images. Finally, at block 180, the images are displayed on the television set.

FIG. 5 also illustrates an alternative embodiment of the system work-flow wherein the images are received wirelessly (not shown) or via a tethered communication (see FIG. 1-b) from a digital camera at block 112. Image processing (e.g. downsampling) at block 114 and local storage at block 116 functions are performed by the remote control unit prior to initiating the communications link at block 130, and subsequently transmitting a slideshow of the images at block 140 for display on a user's TV set at block 180. The example of FIG. 5 may be applied to video and/or audio data, as well, and it may be applied to output at a printer (see FIG. 1-c).

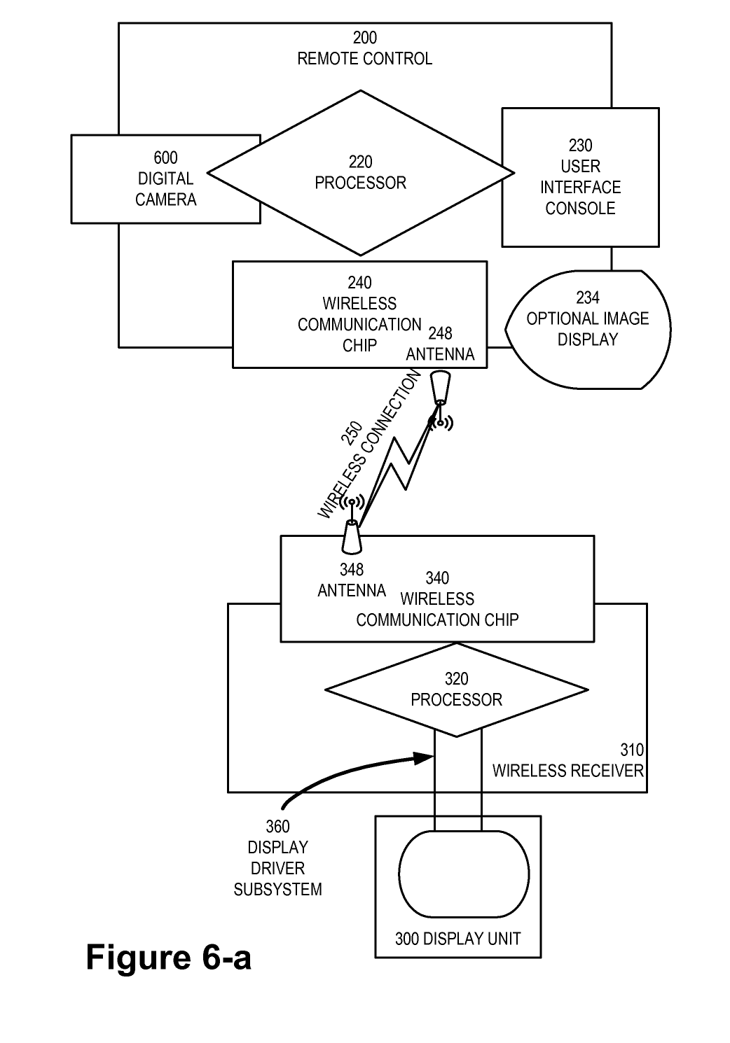

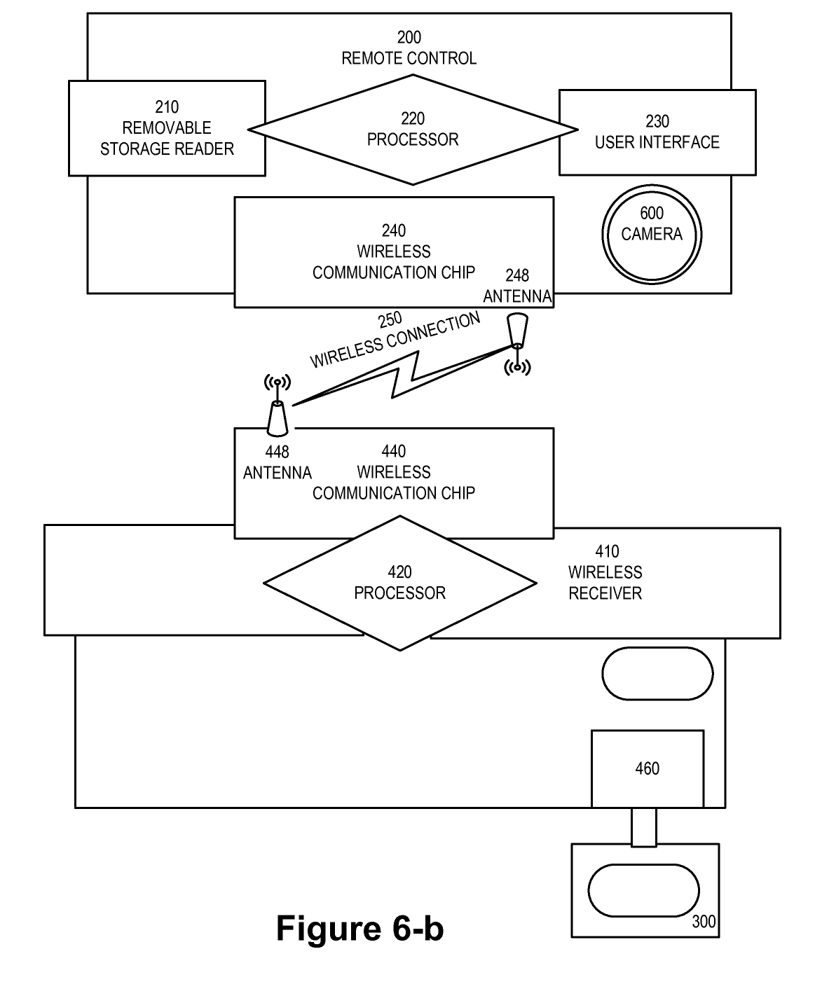

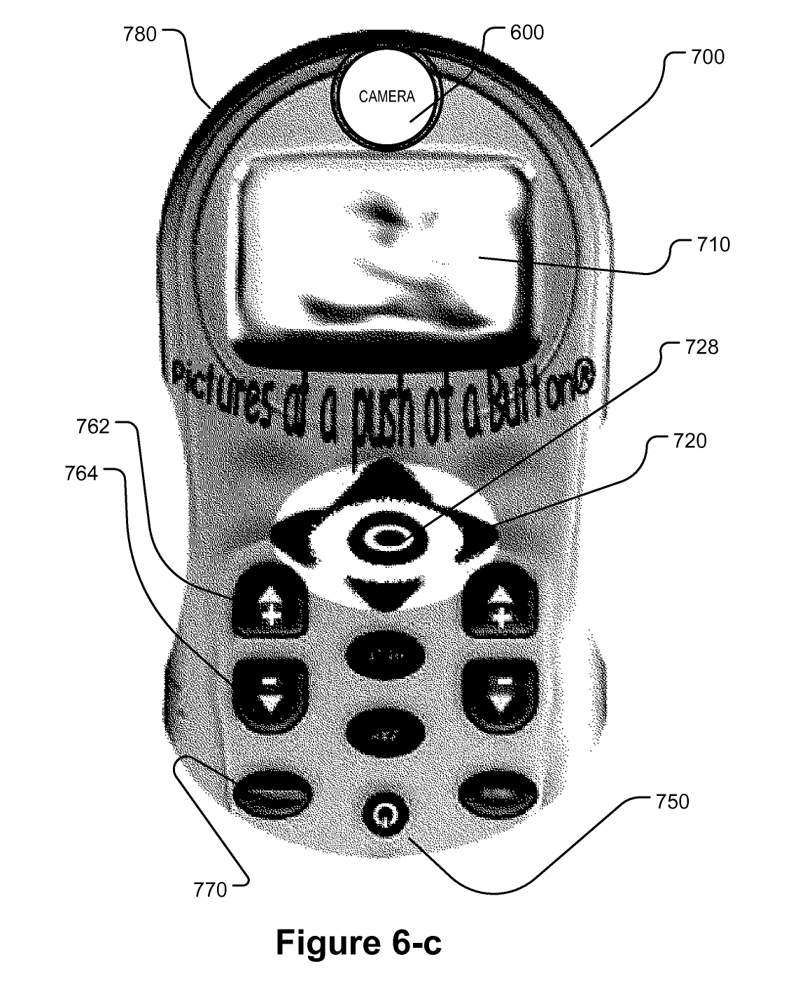

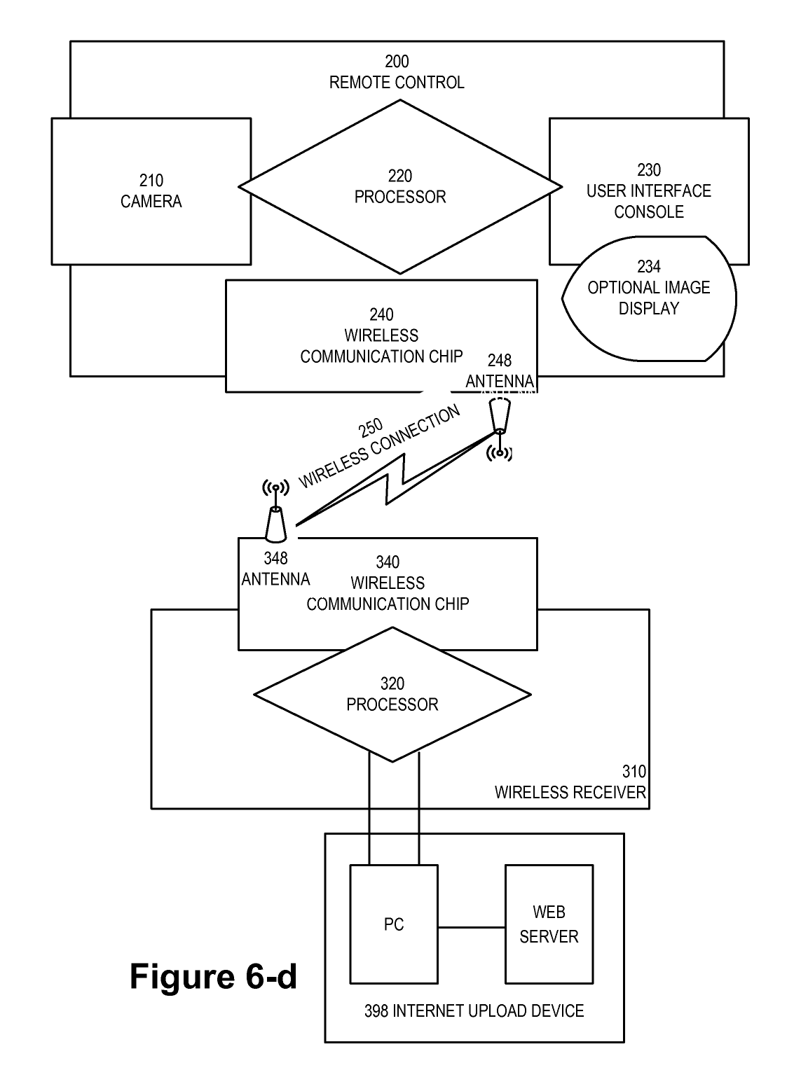

FIG. 6a schematically illustrates a camera-enabled remote control handset in wireless communication with a wireless receiver and display unit in accordance with certain embodiments. The system illustrated in FIG. 6a includes a remote control unit 200, which may be implemented as a handset, e.g., as illustrated in FIG. 6c to be discussed below, and/or a docking station. The remote control unit 200 of FIG. 6a is shown communicatively coupled with a wireless receiver 310. The remote control unit 200 comprises a camera 210 and a main processor 220. The camera 210 includes a lens, and an image sensor. The main processor may include an embedded processor such as a dedicated system-on-chip integrated circuit, for example, a standard ARM or MIPS based embedded system. The processor 220 shown in FIG. 6a may be interfaced to a number of peripheral subsystems commonly found in consumer remote control units: a user interface console 230 and a wireless communications chip 240. An image store and hardware and/or software implemented image processing components may also be included for red eye or other flash-induced eye defect correction, face detection, tracking, recognition and processing and image capture based on detected, recognized and/or tracked faces, dust artefacts or other blemish correction, foreground background, 3D, panorama, face modelling, face feature detection including smile, blink and occlusion detection, scene analysis, face beautification and chromatic aberration correction, see, e.g., U.S. Ser. Nos. 61/362,247, 12/883,183, 12/879,003, 12/827,868, 12/824,204, 12/820,002, 12/784,418, 12/572,930 and 12/636,618, and US published apps US 2010/0141786, US 2010/0066822, US 2010/0053362, US 2010/0026831, US 2009/0303343, US 2009/0303342, US 2009/0179999, US 2009/0190803, US 2009/0189997, US 2009/0189998 US 2009/0238419 and US 2009/0167893and U.S. Pat. Nos. 7,809,162, 7,804,531, 7,796,822 7,792,335, 7,787,022, 7,746,385, 7,715,597, 7,702,236, 7,702,136, 7,697,778, 7,692,696, 7,680,342, 7,689,009, 7,620,218, 7,587,068, 7,515,740, 7,469,071, 7,403,643, 7,336,821, 7,340,109, and 6,407,777, which are each assigned to Fotonation as with the present case and hereby incorporated by reference for all purposes including as disclosing alternative embodiments. The user interface console 230 is, for example, a keyboard subsystem allowing the user to select and initiate various control functions by initiating the wireless transfer of control codes to a remote CE appliance such as a TV set or other display unit 300.

Instead of or in addition to display 300, a hardcopy device such as color printer 390 of FIG. 1c may be included. In this embodiment, a printer driver 395 also of FIG. 1c may be used instead of the display driver subsystem 360 shown in FIG. 6a.

The image display 234 may be a LCD display. The display 234 may be an uncomplicated alphanumeric display, or may be a more sophisticated graphical color LCD display or interactive display. or any other display device known to those skilled in the art. A wireless communication chip 240 is preferably employed to communicate control codes (instructions) to the remote CE appliance 300, 390. An infrared based means of transmitting control codes may be employed, or alternative communication means such as Bluetooth or WiFi, WUSB or WLAN may be used. Such Radio Frequency communications may use an antenna 248. These and other subsystems may be used including those that may be common to domestic remote control units for direct control of a CE appliance 300, e.g., those that bypass wireless receiver 310.

A system in accordance with the embodiment of FIG. 6a, as well as FIGS. 6b-6d, has the advantage that digital audio and/or visual (A/V) content data may be acquired by the remote control unit 200 using built-in digital camera 600. Moreover, such acquired data may be stored in internal storage in the remote control 200, and may be further managed, manipulated, combined and otherwise processed by the processor 220 on the remote control unit 200. After this data has been accessed and suitably prepared, it may be transmitted to the remote wireless receiver 310 along with a sequence of control codes instructing the receiver 310 as to the handling and playing/displaying of the data.

The wireless receiver 310 of FIG. 6a includes a main processor 320, preferably an embedded processor, typically a dedicated system-on-chip integrated circuit. This processor 320 is connected to two main peripheral subsystems: a wireless communication chip 340 with antenna 348 and a display driver subsystem 360, for example, an RGB/NTSC/PAL/D1/VGA/HDTV/D1-4 interface which is connected, in turn, to a CE display unit such as a conventional TV set 300. The wireless communication chip 340 is employed to receive, via the wireless connection 250, control codes transmitted from the remote control unit 200 and, in addition, A/V data which acquired with built-in digital camera component 600 of remote control unit 200 is provided.

The protocol used on the wireless connection 250 may be generic or a specific protocol for the imaging devices used. Examples include using similar protocol between image acquisition devices and hosts such as PTP or in the wireless case PTP-IP or MTP over IP (“MTP-IP”). The CE display unit 300 of the embodiment illustrated at FIG. 6a may be a digital display unit such as an LCD panel or HDTV.

When A/V content data is acquired with camera 600, it may be tagged by an identifier indicating the type or format of the content (i.e. audio, visual or both) and may also incorporate additional metadata including recording image processing modifications performed on the remote control unit 200 and/or conditions of capture with camera 600. Image processing may alternatively or additionally be performed by the processor 320 on the receiver 310. The receiver-side image processing may be responsive to metadata associated with the A/V content data. As an example, a user may program a video or slideshow sequence on the remote control unit 200 and then transmit the resulting A/V data to the receiver 310. Further image processing, including transition effects, redeye removal, blemish removal such as from dust, and/or motion blur compensation can be performed in the receiver 310 prior to the actual rendering of the video or slideshow image sequence on a TV or other display unit 300. Such image processing may also be managed directly from the remote control unit 200. Thus, the receiver 310 may directly control the display unit 300 to play (in the case of audio or movies) and/or display (in the case of still images) the A/V content data.

Alternatively, remote control unit 200 may control the unit 300 indirectly via the receiver. Such control may include the transition between objects, editing the object, selecting which objects to display, and/or erasing and reordering objects. Editing objects may include operations such as color correction, red eye reduction, rotation, exposure correction, and cropping.

FIG. 6b schematically illustrates a camera-enabled remote control handset in wireless communication with a wireless receiver, display subsystem and CE appliance in accordance with certain embodiments. In this embodiment, the remote control unit 200 may be the same as or similar to that described in the FIG. 6a. In this case, however, the wireless receiver 410 is connected to a digital camera 400 or similar imaging appliance. An advantage of this alternative embodiment is that a digital camera will, typically, incorporate a display subsystem 460 which allows it to be connected to a conventional audiovisual CE appliance such as a TV set 300. Furthermore, the latest digital cameras incorporate WLAN or Bluetooth subsystems. Accordingly, a digital camera with such wireless communications and display subsystems can be modified to take advantage of the remote control unit 200 with camera 400 and/or removable storage reader 210. In other words, in this embodiment the receiver 410 controls the display unit 300 to play and/or display the A/V content data via digital camera 400.

FIG. 6c schematically illustrates a camera-enabled remote control handset in accordance with certain embodiments, where only a single camera block is intended to indicate that the device includes flash, lens, image sensor, processor and programming of a digital still image, video image and/or audio acquisition, display and or audio output device. FIG. 6c illustrates a physical implementation of a remote control unit 700 corresponding to the units 600 and 400, respectively, shown in the block diagrams of FIGS. 6a and 6b. The remote control unit 700, which may have other functions included with conventional remote control units not shown in FIG. 6c, also exhibit some additional features designed to accommodate the principle elements of the embodiments described herein.

First, it includes a built-in camera 600. Camera 600 may face the front or back of the unit 700. For example, the display 710 may be used to preview an image being acquired by the camera 600 when the back of the unit 700 is pointed at the scene desired to be captured. Certain of the buttons 720-770 may be used to set capture conditions such as focus, zoom, exposure, color balance, white balance, orientation, and sharpness, among potentially several other parameters.

Second, the unit 700 may incorporate a slot 780 in the casing of the remote control unit to accommodate the insertion and removal of a removable storage medium. Alternatively, slot 780 may be a USB master plug which will accept a USB cable from any of a variety of devices. In addition, it may incorporates special function keys 770 to initiate customized image processing algorithms which can enhance or improve the digital content that may be accessed and further managed, manipulated, combined or otherwise processed on the remote control unit 700.

In addition to automated image processing functions, the remote control unit 200, 700 may optionally incorporate a graphical LCD display 710 which can display images acquired by the camera 400, 600, and/or loaded from a removable storage medium subsystem. This allows for additional image processing and enhancement functions to be performed on the remote control unit 700 where user input from the remote control keys 762, 764 may be used to adjust a parametric input to the image processing and functions such as brightness or exposure.

Further advanced functionality can be achieved using more complex user input such as may be obtained from an “arrow-key” input button 720 which can allow accurate panning, zooming and scrolling of a selected image. An OK/Enter button is indicated at 728 and an ON/OFF button is indicated at 750 of FIG. 6c.

FIG. 6d schematically illustrates a camera-enabled remote control handset in wireless communication with a wireless receiver and internet upload device in accordance with certain embodiments. According to this embodiment, data such as internet content or web content may be communicated to an internet upload device 398, such as a pc or other processor-based device that is connected to a web server. The internet or web content may be acquired by the digital camera component 210 of the remote control handset 200. In addition to camera 210, the remote control handset 200 may include a processor 220, user interface console 230, display 234 and wireless communication chip 240 with antenna 248 for establishing a wireless connection 250 to an antenna 348 of a wireless communication chip 340 of a wireless receiver 310 that also includes a processor 320. The wireless receiver may be connected to an internet upload device, e.g., including a PC connected to a web server as illustrated. The remote control 200 may instead communicate directly with the internet upload device 398. The remote control handset may further include a web browser and/or email, text and/or phone capability. The content may be uploaded to a web page or a database or other construct that is accessible via the internet.

### ALTERNATIVE EMBODIMENTS

The following publications, as well as other publications cited above and below herein, and the background, invention summary, brief description of the drawings and abstract, are hereby incorporated by reference as disclosing alternative embodiments or features not otherwise described in detail above:

[PTP] PTP/ISO-15740, “Picture Transfer Protocol Specification”, http://www.i3a.org/downloads_it10.html;

[USB] USB Device Working Group, “USB Still Image Capture Device Definition”, http://www.usb.org/developers/devclass_docs/usb_still_img10.pdf;

[CIPA] CIPA, “CIPA DC-001-2003 Digital Photo Solutions for Imaging Devices”, http://www.cipajp/pictbridge/contents_e/03overview_e.html;

[PB] P. Bigioi, G. Susanu, P. Corcoran and I. Mocanu, “Digital Camera Connectivity Solutions using the Picture Transfer Protocol (PTP)”, ICCE 2002 and IEEE Transactions on Consumer Electronics, vol. 48, number 3, pp.417-427, August 2002;

[PTP-IP] PTP/IP Draft Specification—for review purposes only www.fotonation.com/products;

[UPNP] UPNP Forum http://www.upnp.org;

[MTP] ; see Media Transfer Protocol Specification msdn.microsoft.com/library/default.asp?url=/library/en-us/dnwmt/html/mtp_spec.asp.;

The A/V acquisition device 100 that the remote control unit 210 communicates with, in accordance with preferred and alternative embodiments herein, may include an industry accepted (whether as de-facto or de-juro) standard Application Interface Protocol (“API”), or Command Language, that describes the means of retrieving data from the acquisition device. Examples of such interfaces include ISO-15740, aka “Picture-Transfer-Protocol” or “PTP”, which describes a command language between digital cameras and receiving devices; see PTP/ISO-15740, “Picture Transfer Protocol Specification”, www.i3a.org/downloads_it10.html.

Such command languages may also have a transport layer component which can be tethered or IP based such as USB Still Image Device Class definition which correlates to the implementation of PTP over USB; see USB Device Working Group, “USB Still Image Capture Device Definition”, www.usb.org/developers/devclass_docs/usb_still_img10.pdf or PTP over IP (“PTP-IP”) which correlates to the implementation of PTP over Internet Protocols; see PTP/IP Draft Specification—www.fotonation.com/products.

There may be a specified protocol on top of the PTP for output of images. One example is PictBridge (see , “CIPA DC-001-2003 Digital Photo Solutions for Imaging Devices”, http://www.cipajp/pictbridge/contents_e/03overview_e.html for specification) which describes such output protocol that may be used in an embodiments for printing purposes.

Another protocol is the Universal Plug-and-Play Orienting protocol [uPNP]. In generic multi media device cases, such protocol may be Multi Media Transfer Protocol (“MTP”).

The present invention is not limited to the embodiments described above herein, which may be amended or modified without departing from the scope of the present invention as set forth in the appended claims, and structural and functional equivalents thereof. In addition, in methods that may be performed according to preferred embodiments herein and that may have been described above and/or claimed below, the operations have been described in selected typographical sequences. However, the sequences have been selected and so ordered for typographical convenience and are not intended to imply any particular order for performing the operations.

What is claimed is:

1. An apparatus for the remote wireless control of a consumer electronic (CE) appliance, comprising:
remote control handset that is configured to one or both of directly control the CE appliance, or indirectly via a wireless receiver, for playing, displaying, transitioning or editing audio or visual data (hereinafter “A/V” data), or combinations thereof, including a push-button image processing interface including multiple push-buttons configured to be depressible by one or more fingers or a thumb or both of a same hand within which the remote control handset is being held by a user; and
wherein the remote control handset comprises an A/V device and a display;
wherein the remote control unit is configured for processing A/V data prior to transmission for output at the CE appliance, or a wireless receiver coupled to the CE appliance is configured for processing the A/V data prior to playing or displaying the data, or both, on the CE appliance, or both; and
wherein the remote control unit is configured to transmit the A/V data and control codes wirelessly to the CE appliance or to the wireless receiver, or both; and
wherein the CE appliance or the wireless receiver, or both, is configured to be responsive to the A/V data and control codes from the remote control handset, and to output the A/V data at the CE appliance, and
wherein the CE appliance or the wireless receiver or the remote control handset, or combinations thereof, is configured to process the A/V data responsive to metadata associated with the A/V data, including dust or other blemish removal, motion blur compensation, transition effects, color correction, exposure correction, red eye reduction, rotating, panning, scrolling or cropping, or editing an object, selecting which objects to display, or erasing and reordering objects, or combinations thereof, under the push-button control of the remote control handset for providing a processed image or processed A/V data, or both, to be output at the CE appliance based on the processed image data.

2. The apparatus as claimed in claim 1, wherein the remote control handset is further configured to directly control the CE appliance.

3. The apparatus as claimed in claim 1, wherein the remote control handset is configured to indirectly control the CE appliance through the wireless receiver.

4. The apparatus as claimed in claim 1, wherein said remote control handset further comprises an internal storage for storing A/V data.

5. The apparatus as claimed in claim 1, wherein said remote control handset comprises internal storage, wherein A/V data is saved on said internal storage.

6. The apparatus as claimed in claim 1, wherein said interface is configured according to Picture Transfer Protocol (“PTP”).

7. The apparatus as claimed in claim 1, wherein the A/V device comprises a digital stills camera.

8. The apparatus as claimed in claim 1, wherein the A/V device comprises a digital video camera.

9. The apparatus as claimed in claim 1, wherein the A/V device comprises a digital audio player.

10. The apparatus as claimed in claim 1, wherein the consumer electronic appliance comprises a display unit.

11. The apparatus as claimed in claim 10, wherein the display unit comprises a television set.

12. The apparatus as claimed in claim 10, wherein the display unit is controlled directly by the wireless receiver.

13. The apparatus as claimed in claim 1, wherein the remote control unit is configured for processing A/V data prior to transmission to the wireless receiver or directly to the CE appliance, or both.

14. The apparatus as claimed in claim 1, wherein the wireless receiver is configured for processing the A/V data prior to playing or displaying the data, or both, on the CE appliance.

15. A method for the remote wireless control of a consumer electronic (CE) appliance, comprising:
acquiring audio or visual data, or both (hereinafter “A/V” data) at an A/V device component of a remote control handset, wherein the interface of the remote control handset comprises a display unit;
processing A/V data prior to transmission to a wireless receiver coupled to the CE appliance, or controlling processing of the A/V data prior to playing or displaying the data, or both, at the CE appliance or at a wireless receiver coupled to the CE appliance, or combinations thereof;
transmitting the A/V data and control codes to the wireless receiver or CE appliance, or both, wherein the wireless receiver or CE appliance, or both, is configured to be responsive to the A/V data and control codes from the remote control handset to control the CE appliance to output the A/V data, including directly or indirectly controlling the CE appliance for playing, displaying, transitioning or editing the A/V data, or combinations thereof;
performing A/V data processing at the wireless receiver or CE appliance or remote control handset, or combinations thereof, in response to metadata associated with the A/V data, wherein the processing at the wireless receiver or CE appliance or remote control handset, or combinations thereof, includes dust or other blemish removal, motion blur compensation, transition effects, color correction, exposure correction, red eye reduction, rotating, panning, scrolling or cropping, or editing an object, selecting which objects to display, or erasing and reordering objects, or combinations thereof;
controlling the A/V data processing with the remote control handset including holding the remote control handset in a single hand of a user and, using a push-button image processing interface including multiple push-buttons of the remote control handset, selectably depressing the buttons with one or more fingers or a thumb or both of the same hand within which the remote control handset is being held by the user; and outputting processed A/V data or a processed image, or both, based on the A/V data processing.

16. The method as in claim 15, further comprising directly controlling the CE appliance.

17. The method as in claim 15, further comprising indirectly controlling the CE appliance through the wireless receiver.

18. The method as in claim 17, wherein said controlling indirectly through the wireless receiver comprises controlling the receiver to control the CE appliance for playing, displaying, transitioning or editing said A/V data, or combinations thereof

19. The method as in claim 15, further comprising storing A/V data at an internal storage.

20. The method as in claim 15, further comprising configuring said interface according to Picture Transfer Protocol (“PTP”).

21. The method as in claim 15, wherein the A/V device comprises a digital stills camera.

22. The method as in claim 15, wherein the A/V device comprises a digital video camera.

23. The method as in claim 15, wherein the A/V device comprises a digital audio player.

24. The method as in claim 15, further comprising processing A/V data prior to transmitting to the wireless receiver or directly to the CE appliance, or both.

25. One or more processor readable storage devices having processor readable code embodied thereon, said processor readable code for programming one or more processors to perform a method for the remote wireless control of a consumer electronic (CE) appliance, the method comprising:
acquiring audio or visual data, or both (hereinafter “A/V” data) at an A/V device component of a remote control handset, wherein the interface of the remote control handset comprises a display unit;
processing A/V data prior to transmission to a wireless receiver coupled to the CE appliance, or controlling processing of the A/V data prior to playing or displaying the data, or both, at the CE appliance or at a wireless receiver coupled to the CE appliance, or combinations thereof;
transmitting the A/V data and control codes to the wireless receiver or CE appliance, or both, wherein the wireless receiver or CE appliance, or both, is configured to be responsive to the A/V data and control codes from the remote control handset to control the CE appliance to output the A/V data, including directly or indirectly controlling the CE appliance for playing, displaying, transitioning or editing the A/V data, or combinations thereof;
performing A/V data processing at the wireless receiver or CE appliance or remote control handset, or combinations thereof, in response to metadata associated with the A/V data, wherein the processing at the wireless receiver or CE appliance or remote control handset, or combinations thereof, includes dust or other blemish removal, motion blur compensation, transition effects, color correction, exposure correction, red eye reduction, rotating, panning, scrolling or cropping, or editing an object, selecting which objects to display, or erasing and reordering objects, or combinations thereof;
controlling the A/V data processing with the remote control handset including holding the remote control handset in a single hand of a user and, using a push-button image processing interface including multiple push-buttons of the remote control handset, selectably depressing the buttons with one or more fingers or a thumb or both of the same hand within which the remote control handset is being held by the user; and outputting processed A/V data or a processed image, or both, based on the A/V data processing.

26. The one or more storage devices of claim 25, further comprising a program for directly controlling the CE appliance.

27. The one or more storage devices of claim 25, further comprising a program for indirectly controlling the CE appliance through the wireless receiver.

28. The one or more storage devices of claim 27, wherein said controlling indirectly through the wireless receiver comprises controlling the wireless receiver to control the CE appliance for playing, displaying, transitioning or editing said A/V data, or combinations thereof.

29. The one or more storage devices of claim 25, further comprising a program for reading the A/V data for transmitting to the wireless receiver.

30. The one or more storage devices of claim 25, further comprising an internal storage for storing printer data.

31. The one or more storage devices of claim 25, further comprising a program for configuring said interface according to Picture Transfer Protocol (“PTP”).

32. The one or more storage devices of claim 25, wherein the A/V device comprises a digital camera.

33. The one or more storage devices of claim 25, wherein the A/V device comprises a digital video camera.

34. The one or more storage devices of claim 25, wherein the A/V device comprises a digital audio player.

35. The one or more storage devices of claim 25, further comprising a program for processing A/V data prior to transmitting to the wireless receiver or directly to the CE appliance, or both.

36. An apparatus for the remote wireless control of internet uploading, comprising
a remote control handset that is configured to directly, or indirectly through a wireless receiver, control an internet upload device, or both, for playing, displaying, transitioning, editing, or uploading to the internet, audio or visual data (hereinafter “A/V” data), or combinations thereof, including a push-button image processing interface including multiple push-buttons configured to be depressible by one or more fingers or a thumb or both of a same hand within which the remote control handset is being held by a user, and
wherein the remote control handset comprises an A/V device and a display; and
wherein the remote control handset is further configured to communicate internet content; and
wherein the remote control handset for transmitting the internet content wirelessly to a wireless receiver coupled to an internet upload device, or directly to the internet upload device, or both, for uploading content to be accessible on the internet,
wherein the remote control unit or the wireless receiver or the internet upload device, or combinations thereof, is configured for processing the A/V data prior to uploading content to be accessible on the internet; and
wherein the remote control handset is configured to transmit the A/V data and control codes wirelessly to the wireless receiver, or the internet upload device, or both, and
wherein the wireless receiver or internet upload device, or both, is configured to be responsive to the internet content and control codes from the remote control handset, and to process the A/V data responsive to metadata associated with the A/V data, and to control the internet uploading of the content, and
wherein the wireless receiver or internet upload device or remote control handset, or combinations thereof, is configured to process the A/V data, including dust or other blemish removal, motion blur compensation, transition effects, color correction, exposure correction, red eye reduction, rotating, panning, scrolling or cropping, or editing an object, selecting which objects to display, or erasing and reordering objects, or combinations thereof, under the push-button control of the remote control handset for providing a processed image or processed A/V data, or both, to be uploaded to the internet based on the processed image data.

37. The apparatus as claimed in claim 36, wherein the remote control handset is further configured to directly control the internet upload device.

38. The apparatus as claimed in claim 36, wherein the remote control handset is configured to indirectly control the internet upload device through the wireless receiver.

39. The apparatus as claimed in claim 36, wherein the A/V device of the remote control handset is configured to acquire digital still images.

40. The apparatus as claimed in claim 36, wherein the A/V device of the remote control handset is configured to acquire digital video images.

41. The apparatus as claimed in claim 36, wherein the A/V device of the remote control handset is configured to play and record digital audio.

42. The apparatus as claimed in claim 36, wherein the remote control unit is configured for processing internet content prior to transmission to the wireless receiver, or internet upload device, or both.

43. The apparatus as claimed in claim 36, wherein the wireless receiver or internet upload device, or both, is configured for processing the internet content prior to internet uploading.
